(19) United States
(12) Patent Application Publication
(10) Pub. No.: US 2013/0251469 A1
(43) Pub. Date: Sep. 26, 2013

(54) DOUBLE-SIDED METAL OF DRILLING ENTRY BOARD

(71) Applicants: Yun-Chao YEH, Taoyuan Hsien (TW); Chung-Hao Chang, Taoyuan Hsien (TW); Han-Shiang Huag, Taoyuan Hsien (TW); Jia-Wei Cao, Taoyuan Hsien (TW)

(72) Inventors: Yun-Chao YEH, Taoyuan Hsien (TW); Chung-Hao Chang, Taoyuan Hsien (TW); Han-Shiang Huag, Taoyuan Hsien (TW); Jia-Wei Cao, Taoyuan Hsien (TW)

(21) Appl. No.: 13/472,041

(22) Filed: May 15, 2012

(30) Foreign Application Priority Data
Mar. 21, 2012 (TW) 101205084

(51) Int. Cl. B23B 47/32; B23B 41/16

(52) U.S. Cl. 408/18; 408/72 R

(57) ABSTRACT

A double-sided metal drilling entry board for drilling comprises a metal bottom layer, a soft metal surface layer and a binding layer, in which the binding layer is disposed between the metal bottom layer and the soft metal surface layer to bind the metal bottom layer and the soft metal surface layer.

### FIELD OF INVENTION

The present invention relates to a double-sided metal of drilling entry board for drilling process, and more particularly to a design in which a top layer is a soft metal, so as to achieve an object of guiding a drilling needle, thereby reducing an influence of shift when the drilling needle drill a hole and stabilizing drilling precision and accuracy.

### RELATED ART

In recent years, the electronic products develop to be light and thin, multifunctional and high-speed, and as a result, the proportion of number and density of micro-pores on a printed circuit board increase drastically. Based on such a trend, the efficacies such as the drilling quality, position accuracy and the drilling needle service life become important indexes. However, the conventional auxiliary plates such as drilling entry boards made of a conventional aluminum foil or phenolic resin are no longer applicable to the applications of such requirements, and the forced use causes undesirable deficiencies such as the bit breakage, hole roughness and drilling needle abrasion.

Now, a different type of metal drilling entry board for drilling (mostly aluminum drilling entry board) is produced correspondingly. The structure mainly includes at least an aluminum substrate and a lubricating layer bound on the aluminum substrate. When the drilling needle drills a hole, after entering the lubricating layer and the aluminum substrate, the drilling needle achieves objects of lubrication and thermal conduction.

The above structure achieves the expected objects. However, during practical implementation, the lubricating layer at the top of the metal drilling entry board is melted under heat to lubricate the drilling needle, so that when the drilling needle touches the lubricating layer, the lubricating layer fails to properly guide the drilling needle to drill downward. As a result, once the aluminum substrate at the bottom layer is reached, due to the high hardness of the aluminum substrate, the drilling needle easily slips, causing hole misalignment or bit breakage.

### SUMMARY OF THE INVENTION

The present invention is directed to a double-sided metal of drilling entry board for drilling, which is capable of effectively guiding a drilling needle, reducing an influence of shift when a drilling needle drills a hole, so as to stabilize the accuracy and precision of drilling.

In order to achieve the above object, a double-sided metal of drilling entry board for drilling of the present invention includes a metal bottom layer, a soft metal surface layer and a binding layer, in which the binding layer is disposed between the metal bottom layer and the soft metal surface layer to bind the metal bottom layer and the soft metal surface layer.

In implementation, the hardness of the soft metal surface layer is lower than that of the metal bottom layer.

In implementation, a hardness value of Shore hardness D of the soft metal surface layer ranges from 10 to 30, and a hardness value of Shore hardness D of the metal bottom layer ranges from 30 to 90.

In implementation, a material of the soft metal surface layer and the metal bottom layer is aluminum.

In implementation, the soft metal surface layer is an aluminum foil, and the metal bottom layer is an aluminum sheet.

In implementation, the binding layer is an adhesive layer for adhering the soft metal surface layer and the metal bottom layer.

In implementation, the binding layer is a lubricating material.

In implementation, the binding layer is added with a lubricating material.

In implementation, a hardness value of Shore hardness D of the binding layer ranges from 10 to 30.

In implementation, the lubricating material is any one of nonyl phenol polyethylene glycol ether, polyethylene glycol (PEG), polyvinyl alcohol (PVA), polyacrylic acid, polyethylene alkyl esters, polyamides or epoxy resin. Alternatively, the lubricating material includes one of PEG, polyether-siloxane copolymer, branch siloxane copolymer and polyvinyl pyrrolidone (PVP).

In implementation, the binding layer may be added with a compound of high thermal conductivity, and the compound of high thermal conductivity is one of aluminum hydroxide (Al(OH)₃), aluminum oxide (Al₂O₃), boron carbide (BN) and aluminum nitride (AlN).

In implementation, the thickness of the soft metal surface layer is less than that of the metal bottom layer.

In order to make the present invention more comprehensible, features and effects of the present invention are described in detail below through preferred embodiments with reference to the drawings and drawing numbers.

### BRIEF DESCRIPTION OF THE DRAWINGS

FIG. 1 is a schematic structural view of an embodiment of the present invention; and

FIG. 2 is a schematic view of a state during drilling according to an embodiment of the present invention.

### DETAILED DESCRIPTION OF THE INVENTION

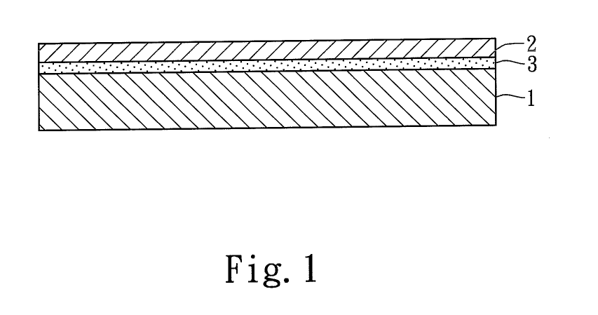

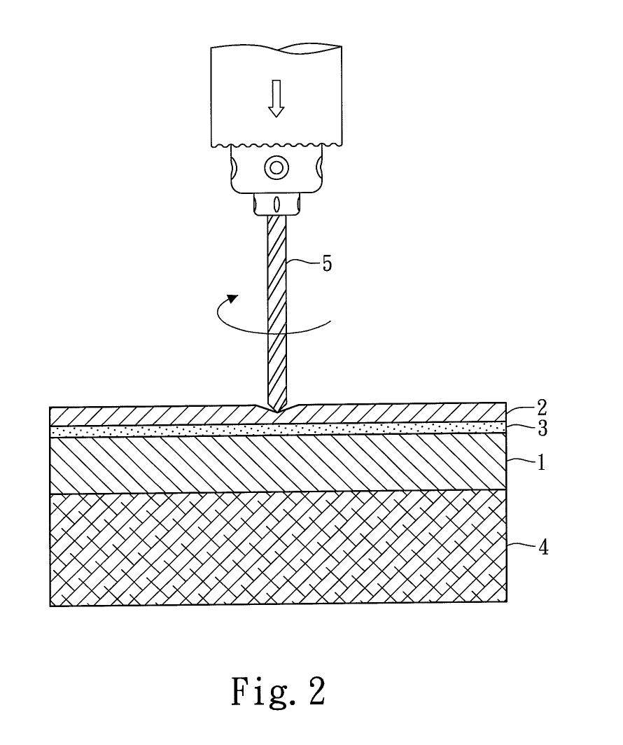

Referring to FIG. 1 and FIG. 2, the content thereof is an embodiment of a double-sided metal drilling entry board for drilling according to the present invention, which is formed by a metal bottom layer 1, a soft metal surface layer 2 and a binding layer 3. After being disposed on a printed circuit board 4, the double-sided metal drilling entry board for drilling is used for a drilling needle 5 to perform a drilling operation.

The binding layer 3 is disposed between the metal bottom layer 1 and a soft metal surface layer 2 to bind the metal bottom layer 1 and the soft metal surface layer 2.

The hardness of the soft metal surface layer 2 is lower than that of the metal bottom layer 1. The thickness of the soft metal surface layer 2 is lower than that of the metal bottom layer 1. A hardness value of Shore hardness D of the soft metal surface layer ranges from 10 to 30, and a hardness value of Shore hardness D of the metal bottom layer ranges from 30 to 90. A material of the soft metal surface layer 2 and the metal bottom layer 1 is aluminum. An optimal implementation manner is that the soft metal surface layer 2 is an aluminum foil, and the metal bottom layer is an aluminum sheet.

The binding layer 2 may be an adhesive layer for adhering the soft metal surface layer 2 and the metal bottom layer 1 or a lubricating material, or may be an adhesive layer added with a lubricating material or a compound of high thermal conductivity. A hardness value of Shore hardness D of the binding layer ranges from 10 to 30. During implementation, the lubricating material is any one of nonyl phenol polyethylene glycol ether, PEG, PVA, polyacrylic acid, polyethylene alkyl esters, polyamides or epoxy resin. Alternatively, the lubricating material includes one of PEG, polyether-siloxane copolymer, branch siloxane copolymer and PVP. The compound of high thermal conductivity is one of Al(OH)₃, Al₂O₃, BN and AlN.

In this manner, during the drilling operation, when the drilling needle 5 drills from the soft metal surface layer 2, a recess is formed at a force application point of the metal surface layer 2 of certain harness, to effectively guide the drilling needle 5 to drill, so that the drilling needle 5 does not have the problem of shifting.

Therefore, the present invention has following advantages.

1. In the double-sided metal drilling entry board for drilling, through a design of upper and lower metals, after the drilling needle touches the soft metal of the upper layer, the soft metal effectively guides the drilling needle to advance, thereby effectively reducing an influence of shift when the drilling needle drills a hole, and stabilizing the accuracy and precision of drilling.

2. In the present invention, the binding layer between the two metals not only binds the two metals, but is also added with a material having lubricating and/or thermal conductive component, so as to have functions such as lubricating the drilling needle and heat dissipation.

As disclosed in above descriptions and attached drawings, the present invention provides a double-sided metal drilling entry board for drilling. It is new and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A double-sided metal drilling entry board for drilling, comprising:
a metal bottom layer;
a soft metal surface layer; and
a binding layer, disposed between the metal bottom layer and the soft metal surface layer to bind the metal bottom layer and the soft metal surface layer.

2. The double-sided metal drilling entry board for drilling as claimed in claim 1, wherein hardness of the soft metal surface layer is lower than that of the metal bottom layer.

3. The double-sided metal drilling entry board for drilling as claimed in claim 2, wherein a hardness value of Shore hardness D of the soft metal surface layer ranges from 10 to 30, and a hardness value of Shore hardness D of the metal bottom layer ranges from 30 to 90.

4. The double-sided metal drilling entry board for drilling as claimed in claim 2, wherein the soft metal surface layer is an aluminum foil, and the metal bottom layer is an aluminum sheet.

5. The double-sided metal drilling entry board for drilling as claimed in claim 1, wherein the binding layer is an adhesive layer for binding the soft metal surface layer and the metal bottom layer.

6. The double-sided metal drilling entry board for drilling as claimed in claim 5, wherein a hardness value of Shore hardness D of the binding layer ranges from 10 to 30.

7. The double-sided metal drilling entry board for drilling as claimed in claim 1, wherein the binding layer is added with a lubricating material.

8. The double-sided metal drilling entry board for drilling as claimed in claim 7, wherein a hardness value of Shore hardness D of the binding layer ranges from 10 to 30.

9. The double-sided metal drilling entry board for drilling as claimed in claim 7, wherein the lubricating material is any one of nonyl phenol polyethylene glycol ether, polyethylene glycol (PEG), polyvinyl alcohol (PVA), polyacrylic acid, polyethylene alkyl esters, polyamides or epoxy resin.

10. The double-sided metal drilling entry board for drilling as claimed in claim 7, wherein the lubricating material comprises one of polyethylene glycol (PEG), polyether-siloxane copolymer, branch siloxane copolymer and polyvinyl pyrrolidone (PVP).

11. The double-sided metal drilling entry board for drilling as claimed in claim 7, wherein the binding layer is added with a compound of high thermal conductivity, and the compound of high thermal conductivity is one of aluminum hydroxide (Al(OH)₃), aluminum oxide (Al₂O₃), boron carbide (BN) and aluminum nitride (AlN).

12. The double-sided metal drilling entry board for drilling as claimed in claim 1, wherein the binding layer is a lubricating material.

13. The double-sided metal drilling entry board for drilling as claimed in claim 12, wherein a hardness value of Shore hardness D of the binding layer ranges from 10 to 30.

14. The double-sided metal drilling entry board for drilling as claimed in claim 12, wherein the lubricating material is any one of nonyl phenol polyethylene glycol ether, polyethylene glycol (PEG), polyvinyl alcohol (PVA), polyacrylic acid, polyethylene alkyl esters, polyamides or epoxy resin.

15. The double-sided metal drilling entry board for drilling as claimed in claim 12, wherein the lubricating material comprises one of polyethylene glycol (PEG), polyether-siloxane copolymer, branch siloxane copolymer and polyvinyl pyrrolidone (PVP).

16. The double-sided metal drilling entry board for drilling as claimed in claim 12, wherein the binding layer is added with a compound of high thermal conductivity, and the compound of high thermal conductivity is one of aluminum hydroxide (Al(OH)₃), aluminum oxide (Al₂O₃), boron carbide (BN) and aluminum nitride (AlN).

17. The double-sided metal drilling entry board for drilling as claimed in claim 1, wherein a hardness value of Shore hardness D of the soft metal surface layer ranges from 10 to 30, and a hardness value of Shore hardness D of the metal bottom layer ranges from 30 to 90.

18. The double-sided metal drilling entry board for drilling as claimed in claim 1, wherein the soft metal surface layer is an aluminum foil, and the metal bottom layer is an aluminum sheet.

19. The double-sided metal drilling entry board for drilling as claimed in claim 1, wherein a hardness value of Shore hardness D of the binding layer ranges from 10 to 30.

20. The double-sided metal drilling entry board for drilling as claimed in claim 1, wherein the binding layer is added with a compound of high thermal conductivity, and the compound of high thermal conductivity is one of aluminum hydroxide (Al(OH)₃), aluminum oxide (Al₂O₃), boron carbide (BN) and aluminum nitride (AlN).
